(19) United States
(12) Patent Application Publication
(10) Pub. No.: US 2026/0035071 A1
(43) Pub. Date: Feb. 5, 2026

(54) 4-PYLON EVTOL WIG

(71) Applicant: Sergey A. ORLOV, London (CA)

(72) Inventor: Sergey A. ORLOV, London (CA)

(21) Appl. No.: 18/732,966

(22) Filed: Jun. 4, 2024

Related U.S. Application Data
(60) Provisional application No. 63/628,332, filed on Jul. 13, 2023.

(51) Int. Cl. B64C 35/00; B64C 17/00; B64C 29/00; B64C 37/00

(52) U.S. Cl. CPC B64C 35/008; B64C 17/00; B64C 29/0033; B64C 35/006; B64C 37/00

(57) ABSTRACT

An aerial and preferably marine vehicle intended to operate in its principal mode near the surface of water or land employing the Wing-in-Ground Effect (WIG) and capable to take-off and land vertically (VTOL) by means of thrust vectoring, which vehicle has a wing arranged at the lowermost part of the fuselage, propulsion units comprising four rotatable pylons extending transversely in pairs on both sides of the upper part of the fuselage, four elongated nacelles mounted on the outer tips of said pylons, which nacelles contain electric motors (E) and provided with propellers at their extremities, so that the rotation of the pylons results in turning the nacelles and thrust of propellers from substantially vertical, ensuring take-off and landing, to substantially horizontal providing a flight mode, retractable hydroskis for emergency landing on water, while said propulsion units and said wing are spaced apart vertically and horizontally and do not overlap.

### REFERENCE TO RELATED APPLICATIONS

### Related U.S. Application Data

Provisional application No. 63/628,332, filed on Jul. 13, 2023.

Int. Cl. . . . B64C 27/26; B64C 27/28; B64C 29/00; B64C 29/0016; B64C 29/0033; B64C 29/0075; B64C 35/00; B64C 37/00

### U.S. Cl.

CPC. 244/7R; 244/12.4; 244/17.23; 244/17.27; 244/55; 244/56; 244/66; 244/69; 244/82; 244/102R; 244/105; 244/106; 244/107

### Field of Classification Search

CPC 244/7R; 244/12.4; 244/17.23; 244/17.27; 244/55; 244/56; 244/66; 244/69; 244/82; 244/102R; 244/105; 244/106; 244/107

### References Cited

U.S. PATENT DOCUMENTS

| | | |
|---|---|---|
| 1,061,434 | May 1913 | Willows |
| 2,929,580 | March 1960 | Ciolkosz |
| 2,936,967 | May 1960 | Dancik |
| 3,081,964 | March 1963 | Quenzler |
| 3,089,666 | May 1963 | Quenzler |
| 3,141,633 | July 1964 | MacKay |
| 3,181,810 | May 1965 | Olson |
| 3,190,582 | June 1965 | Lippisch |
| 3,298,633 | January 1967 | Dastoli et al. |
| 3,360,217 | December 1967 | Trotter |
| 3,430,894 | March 1969 | Strand et al. |
| 3.499,620 | March 1970 | Haberkorn et al. |
| 3,528,630 | September 1970 | Ferris et al. |
| 3,578,263 | May 1971 | Gunter |
| 3,599,903 | August 1971 | Handler |
| 3,903,832 | September 1975 | Ishida |
| 4,484,721 | November 1984 | Gue |
| 4,504,029 | March 1985 | Eickmann |
| 4,605,185 | August 1986 | Reyes |
| 4,789,115 | December 1988 | Koutsoupidis |
| 4,925,131 | May 1990 | Eickmann |
| 4,962,978 | October 1990 | Weston |
| 5,065,833 | November 1991 | Matsuoka et al. |
| 5,115,996 | May 1992 | Moller |
| 5,136,961 | August 1992 | Follett |
| 5,415,365 | May 1995 | Ratliff |
| 5,419,514 | May 1995 | Ducan |
| 5,622,133 | April 1997 | Sinitsyn et al. |
| 5,823,468 | October 1998 | Bothe |
| 6,293,491 | September 2001 | Wobben |
| 6,340,133 | January 2002 | Capanna |
| 6,607,161 | August 2003 | Krysinski et al. |
| 6,655,631 | December 2003 | Austen-Brown |
| 6,892,980 | May 2005 | Kawai |
| 7,040,574 | May 2006 | Richards |
| 7,188,802 | March 2007 | Magre |
| 7,861,967 | January 2011 | Karem |
| 8,152,096 | April 2012 | Smith |
| 8,453,962 | June 2013 | Shaw |
| 8,469,306 | June 2013 | Kuhn |
| 8,720,814 | May 2014 | Smith |
| 9,187,174 | November 2015 | Shaw |
| 9,694,908 | July 2017 | Razroev |
| 9,694,911 | July 2017 | Bevirt |
| 9,764,829 | September 2017 | Beckman |
| 10,081,436 | September 2018 | Tian |
| 10,322,796 | June 2019 | Lee |
| 10,364,024 | July 2019 | Tighe et al. |
| 10,392,106 | August 2019 | Vondrell et al. |
| 10,625,855 | April 2020 | Deng |
| 11,174,019 | November 2021 | Moore et al |
| 11,597,511 | March 2023 | Moore et al. |
| 11,603,193 | March 2023 | Kim et al. |
| 11,603,195 | March 2023 | Giannini |
| 11,603,202 | March 2023 | Fredericks |
| 2002/0096600 | July 2002 | Richards |
| 2003/0080242 | May 2003 | Kawai |
| 2003/0085319 | May 2003 | Wagner et al. |
| 2003/0094537 | May 2003 | Austen-Brown |
| 2004/0245374 | December 2004 | Morgan |
| 2005/0230519 | October 2005 | Hurley |
| 2006/0016930 | January 2006 | Pak |
| 2011/0001020 | January 2011 | Forgac |
| 2011/0303795 | December 2011 | Oliver |
| 2012/0012692 | January 2012 | Kroo |
| 2012/0043413 | February 2012 | Smith |
| 2012/0061509 | March 2012 | Brunken, Jr. |
| 2012/0119016 | May 2012 | Shaw |
| 2013/0099065 | April 2013 | Stuhlberger |
| 2013/0264429 | October 2013 | Miodushevsky |
| 2015/0136897 | May 2015 | Seibel et al. |
| 2015/0266571 | September 2015 | Bevirt et al. |
| 2015/0360775 | December 2015 | Arai |
| 2016/0207625 | July 2016 | Judas et al. |
| 2016/0236774 | August 2016 | Niedzballa |
| 2016/0311530 | October 2016 | Smith |
| 2017/0036771 | February 2017 | Woodman |
| 2017/0174342 | June 2017 | Huang |
| 2018/0065739 | March 2018 | Vondrell et al. |
| 2018/0105279 | April 2018 | Tighe et al. |
| 2019/0135425 | May 2019 | Moore et al. |
| 2019/0263515 | August 2019 | Karem et al. |
| 2019/0337613 | November 2019 | Villa et al. |
| 2019/0375495 | December 2019 | Pfammatter et al. |
| 2020/0115045 | April 2020 | Mermoz et al. |
| 2020/0324894 | October 2020 | Fredericks |

### OTHER PUBLICATIONS

1. Sighard F. Hoerner, “Fluid-Dynamic Drag”, (1965).
2. Sighard F. Hoerner and Henry V. Borst, “Fluid-Dynamic Lift”, (1985).

### 20 Claims, 11 Drawings Sheets

### FIELD OF THE INVENTION

The present invention relates mainly to designs of aerial marine vehicles employing the concept of the Wing-in-Ground Effect (WIG) being capable to take-off and land vertically (VTOL) and, in particular, WIGs propelled by electric motors (E), which combination of technologies provides resulting EVTOL WIGs with new operational capabilities and ensues realization of the full potential efficiency of the WIG concept in excess of the efficiency of aircraft.

### PRIOR ART

As the Prior Art of the present invention there should be considered relevant previously developed designs of aerial vehicles employing the Wing-in-Ground Effect (WIG) technology for their principal mode of operation, being provided with the vertical take-off and landing capabilities (VTOL) and using preferably prime electric motors (E) in their propulsion systems.

That is, in the application to the aerial vehicle according to this invention there should be reviewed, first of all, aerial vehicles that use the effect of increasing the lift force and reducing inductive resistance of an airfoil flying near the surface of land or water, which effect leads to an increase in the efficiency of such airfoil and the aerial vehicle utilizing this effect compared to the airfoil of a conventional aircraft and such aircraft as a whole during flight at its normal high operating altitudes.

It should be noted that the efficiency of aerial vehicle is primarily understood here as its aerodynamic efficiency, which implies the minimization of aerodynamic drag for a vehicle in its flight mode and can be expressed in its simplest form as the ratio of the weight of the vehicle to its resistance.

Information about vehicles using such a combination of technologies as WIG, VTOL and E is very scarce and as one known available example, there can be mentioned unmanned autonomous shipping EVTOL WIG vehicle S30 developed by Speeder Systems.

Like the vehicle according to this invention, the S30 is characterized by one fuselage and low-positioned wings, which allows more full use of the concept of the Wing-in-Ground Effect.

However, the wings of S30 are arranged in the “canard” aerodynamic configuration with the main wing in the aft part of the vehicle, which is one of its differences from the vehicle according to this invention featuring the “airplane” aerodynamic configuration. Vertical take-off and landing of the S30 is carried out using turnable ducted fans located at the aft extremity of the vehicle (which, when turned to a horizontal position, serve as the propulsion unit of the flight mode), and, depending on the modifications shown, either one central fan built into the front of the fuselage, or two low-positioned propellers mounted on two fixed longitudinal pylons between the forward and aft wings on both sides of the fuselage.

The disadvantage of the first modification is that the built-in fan occupies a significant useful volume of the fuselage, which in turn limits its diameter and can make it suboptimal with a corresponding decrease in efficiency. Enlarging the diameter to the optimum can lead to an increase in the frontal area of the fuselage and an increase in its aerodynamic drag, resulting in an increase in drag and a decrease in the efficiency of the vehicle as a whole.

The latter of the mentioned configurations of S30 raises questions about the operability of the low-lying propeller in the conditions of the claimed possibility of landing the vehicle on water, when the rotating propeller will be exposed to impacts of sea waves, which can cause damage and destruction.

Thus, unlike the vehicle of the present invention, the S30 design does not provide for two pairs of transverse high-positioned turnable pylons, which ensure a safe high location of the propellers and do not limit their diameter without wasting usable fuselage volume.

Therefore, although they belong to the same class of EVTOL WIGs and are characterized by the low wing arrangement necessary for efficient WIGs, neither in the configuration of the wings, nor in the arrangement of the propellers and fans, the aerial vehicle of this invention and the S30 have nothing in common, while the design of the vehicle according to the present invention is free from a number of disadvantages that impede the practical use of the S30.

Considering the current Prior Art, mention should be made of numerous designs and inventions of various aerial vehicles and aircraft in the field of VTOL and especially EVTOL, which do not intend to use the Wing-in-Ground Effect and do not directly relate to EVTOL WIG of this invention ensuring much greater aerodynamic efficiency of flight, but may be of comparative interest.

First of all, it should be noted that among the non-WIG aerial vehicles there is a large group of wingless quadcopters with four lifting propellers mounted on four non-turnable pylons.

Some of them have fixed pylons with propellers of substantially vertical axes installed in pairs on both sides of the fuselage and the pairs are spaced along the length of the fuselage. However, as in the case of helicopters, due to the lack of a wing with its aerodynamic lift, the propellers must work constantly in a lifting mode and their axes cannot be turned to a significant degree to a closer to horizontal position, which greatly reduces the efficiency of such vehicles So, their efficiency turns out to be considerably lower compared to conventional aircraft, and even more so in comparison with WIG vehicles, including the EVTOL WIG vehicle according to this invention.

Higher efficiency can be shown by VTOL and EVTOL aerial vehicles that use turnable wings with propellers installed on them instead of pylons. Examples of such designs are the vehicles according to patents: U.S. Pat. No. 11,603,193 B2; U.S. Pat. No. 11,603,195 B2; U.S. Pat. No. 11,603,202 B2.

With respect to this type of VTOL and EVTOL aerial vehicles, it should be noted that, firstly, the rotation of a large main lifting wing requires powerful and heavy drives. The Ground Effect is manifested at small distances of the wing from the surface of the land or water and, if the intention is to use the WIG effect to increase efficiency, such a wing with propellers or ducts, or separate propellers and ducts protruding downward from the plane of the wing, when flying cannot be positioned low and close enough to the surface of land or water, and, accordingly, will not be able to realize the full potential of the Wing-in-Ground Effect technology.

In contrast, in the aerial vehicle according to this invention, the propulsion system and the wing are separated and spaced both horizontally and vertically. The propellers are located at the safer upper part of the craft (as far from the water and spraying as possible), positioned above the wing in projection to the transverse plane and not protruding below the wing, so that the propeller-free wing can be mounted at the very bottom of the vehicle, maximizing the potential of the WIG effect.

Thus, ceteris paribus, the mentioned designs of VTOL and EVTOL aerial vehicles with turnable wings will always be inferior in efficiency to the vehicle according to the present invention even they would be meant to exploit the ground effect.

The same conclusion can be reached by considering another group of designs and related patents regarding fixed wing VTOL and EVTOL vehicles, such as, e.g., U.S. Pat. Nos. 3,081,964 and 11,597,511 B2.

The designs of such aerial vehicles do not make it possible to place the wing in the lowest part and assume a high-wing structural configuration, which does not allow full use of the WIG effect and provide the efficiency achievable for the vehicle according to this invention.

Thus, the review of the Prior Art do not reveal any analogues of the aerial vehicle according to this invention, both in its technological niche of the Wing-In-Ground Effect aerial vehicles being capable to take-off and land vertically and driven by electric motors (EVTOL WIGs), and in the wider general field of the vertical take-off and landing aircraft and other kinds of VTOL aerial vehicles, where the aerial vehicle according to this invention, ceteris paribus, will a priori have the advantage in efficiency due to the use of the concept of the Wing-In-Ground Effect.

### BACKGROUND OF THE INVENTION

The present invention relates to designs of aerial vehicles employing Wing-In-Ground Effect technology, which makes it possible to create flying vehicles of high efficiency, exceeding the efficiency of aircraft.

The WIG concept provides for the use of the effect of a significant increase in the aerodynamic efficiency (lift to drag ratio) of an airfoil flying in a close proximity to the surface of land or water.

A significant increase in aerodynamic efficiency in this case is due to a combination of two factors:—an increase in the aerodynamic lift of the airfoil due to an increase in aerodynamic pressure on the lower surface of the wing (facing the nearby surface of the land or water) and a decrease in the induced drag caused by a decrease in the intensity of tip vortices (due to the proximity of the tip of the wing to the surface of the land or water).

The first factor is most pronounced when the distance of the airfoil from the surface is about and less than one wing chord.

The second factor begins to manifest itself noticeably at flight altitudes of less than half the wing span and can reduce the induced drag by approximately half at altitudes in the order of 10% of the wing span.

The increase in lift of the airfoil due to the Ground Effect, in turn, results in a decrease in the required wing area, which leads to a decrease in air friction resistance and, so, a further decrease in aerodynamic resistance of the aerial vehicle as a whole.

Taking into account that the aerodynamic efficiency can be expressed in its simplest form as the ratio of the weight of the vehicle (corresponding to the lift of the wing) to its resistance, the decrease in both inductive drag and air friction drag significantly increases this ratio, resulting in such high values of the achievable aerodynamic efficiency of WIG vehicles, which are unattainable for aircraft.

Despite the fact that WIG vehicles can realize the ground effect over any kind of surface, due to the limited wave heights compared to possible landforms, the most appropriate for them is operation over water surfaces of seas, lakes and rivers.

In this regard, one of the main problems that prevent the full realization of the potential efficiency of WIG vehicles is the problem of taking off from and landing on the water surface.

With the traditional method of takeoff and landing, acceleration in the planing mode along often rough water surface until the liftoff speed is reached, as well as landing on the water surface, is associated with high hydrodynamic shocks caused by water slamming into the large surfaces of the wings and fuselage, which leads to high dynamic loads on the structure of the WIG vehicle, severe and sometimes dangerous shaking for the crew, passengers, equipment and cargo.

The result of this (in addition to shock accelerations affecting everything on board) is the need for significant strengthening of the structure, leading to an increase in weight and a corresponding decrease in the efficiency of the vehicle.

The same problem in the case of a seaplane is solved by using a high-wing configuration in which the wing is out of hydrodynamic impacts.

However, for a WIG vehicle, the high wing position results in the loss of the ground effect, resulting in a significant reduction in the efficiency of the vehicle.

Thus, there is a contradiction that does not allow realizing the full potential of the efficiency of vehicles employing Wing-In-Ground Effect technology at their most appropriate maritime use:

The low position of the wing could provide high efficiency, but it makes it problematic to take off and land vehicle of this configuration from the point of view of hydrodynamic impacts, whereas strengthening the structure of the vehicle leads to a decrease in efficiency.

On the other hand, the possible solution presupposing the removal of the wing from the zone of hydrodynamic impacts in the form of a high-wing configuration also leads to a decrease in efficiency.

The fundamental solution to the above contradiction in this case could be the complete exclusion of hydrodynamic impacts on the WIG vehicle by providing it with the capabilities of vertical takeoff and landing, which would eliminate the problems of slamming and shock accelerations caused by takeoff and landing on water in the high-speed planing mode. Assuming, moreover, that the WIG vehicle will preferably take off from a hard surface and land on a hard surface (ground, helipads), while operating in the flying mode mainly over the water surface.

In this sense, endowing a WIG vehicle with the ability of vertical takeoff and landing can be considered not as an end in itself, but as a way to ensure the trouble-free transition to the most efficient flight mode in the ground effect, while avoiding the problems of conventional WIGs experiencing high hydrodynamic shock loads during runs on the water surface associated with conventional takeoff and landing.

As a direct result of the VTOL capability, the wing (being separated from the propulsion) can be positioned the most optimal way in the lowest part of the vehicle (to be as close as possible to the water surface in the flight mode) for the full implementation of the ground effect and thereby ensuring the maximum efficiency of the WIG vehicle, while avoiding any hydrodynamic loads, which guarantees the minimum weight of the structure and further gain in efficiency.

Such lowermost-positioned propulsion-free wing may consist of an inner, nearer to the fuselage, substantially horizontal wing section that thus makes full use of the ground effect, and positively sloping outer sections that would allow the vehicle to make banked turns at low altitudes corresponding the ground effect.

The end sections of the wing in this case will be positioned at a greater distance from the surface and with less influence of the ground effect, which, accordingly, should lead to some loss of efficiency.

To compensate for these losses, the wing in the projection on the transverse plane can be provided with a broken configuration of the outer ends in the form of the bent down tip sections of the wing.

Such break of the tip sections reduces the inductive drag of the wing and increases the lift of the end sections, which, thereby, leads to an increase in efficiency.

In this case, the positively sloping outer sections will still allow the banked turn of the vehicle, while the steeply sloping down tip sections will not be subject to slamming if they accidentally touch the water surface.

Thus, considering two alternative designs, a wing without the break of the tip section should provide a simpler structural design, but will lose in efficiency to the design with the break.

The aerodynamic feature of the Wing-in-Ground Effect is the displacement of the center of pressure of the wing depending on the distance from the surface in the ground effect mode, which leads to the appearance of pitch moments and pitch imbalance (i.e., angular unbalance of the vehicle in the vertical longitudinal plane).

To compensate for these moments, WIG vehicles are equipped with enlarged (in comparison with conventional aircraft) tail stabilizers, which leads to an increase in parasitic (that is, not associated with the generation of lift) resistance and a decrease in the efficiency of the vehicle.

This negative effect can be completely or partially neutralized by means of a reverse-swept main wing.

Sweeping forward the inner horizontal sections of the wing endows them with a certain self-stabilization, which manifests itself as follows:

If the distance from the surface decreases in the ground effect mode, the center of pressure shifts back, which leads to the appearance of a diving moment and tilting the vehicle nose down. In this case, the outer forward sections of the reverse-swept wing end up in greater ground effect than the inner sections adjacent to the fuselage and located further downstream, which leads to the appearance of a restoring pitching moment, while the opposite effect is observed in the case of increasing distance from the surface.

This effect of self-stabilization of the swept-forward main wing makes it possible to reduce the size of the tail stabilizer and thereby reduce parasitic drag and increase the efficiency of the vehicle.

Correspondingly, a straight (not swept) wing would provide a structurally simpler design, but would lose the effect of self-stabilization in pitch, which would make it necessary to increase the size and area of the tail stabilizer and lead to additional parasitic drag and some reduction in vehicle efficiency.

However, notwithstanding somewhat lower efficiency in comparison with the swept-forward wing embodiment, the low-positioned straight wing should still implement the ground effect with high efficiency and, ceteris paribus, ensure aerodynamic efficiency exceeding efficiency of conventional aircraft.

The propulsion system of such VTOL WIG may include a number of propellers with their axes turnable in longitudinal vertical planes, which ensure the rotation of thrust vectors from vertical for take-off, landing and hovering modes, to horizontal, corresponding to the operational flight mode, while the total vertical thrust vector in the takeoff, landing and hovering modes must correspond to the center of gravity of the vehicle, which requirement can be rationally provided by four propeller installations of the same type located symmetrically on both sides and in front and behind the center of gravity lengthwise.

Consequently, a proper propulsion system of VTOL WIG (meeting the requirements of both vertical take-off and landing, transitional and flight modes) may comprise four rotatable pylons protruding transversely and horizontally in pairs on both sides of the fuselage and forming front and rear coaxial pairs of pylons with transverse axes of rotation, so that the axis of rotation of the front pair is located in front, and the rear—behind said center of gravity of the vehicle lengthwise, and four nacelles provided with propellers, which nacelles mounted on the outer tips of the four rotatable pylons with axes of rotation of said propellers being normal to the axes of rotation of the pylons.

It is assumed that in sections normal to the axes of rotation of the pylons, the pylons have a symmetrical profile streamlined in the direction of the flow and do not participate in the generation of lift.

In this configuration the rotation of the pylons leads to the rotation of the axes of the propellers in vertical longitudinal planes, from a horizontal position of the axes of the propellers corresponding the flight mode to a vertical position corresponding vertical takeoff, hover, and landing modes of the vehicle.

At the same time, to avoid efficiency-reducing aerodynamic interference of propellers' wakes with the planes of the wing during vertical takeoff, hover, and landing modes of vehicle projections of the front pair of propellers onto the horizontal plane are to be in front of the projection of the wing onto this plane and projections of the rear pair of propellers onto the horizontal plane are to be behind the projection of the wing onto this plane, so that projections of the wing and propellers shouldn't overlap.

In the hover mode, the longitudinal movements of the vehicle forward and backward for the purpose of maneuvering can be provided with a slight (by some small angle) rotation of the pylons, relative to the mainly vertically positioned pylons with nacelles and, accordingly, the vertical axes of the propellers.

The transition from the hover mode (during takeoff) to the flight mode is carried out by gradually turning the pylons with nacelles (around the axes of the pylons) forward by 90 degrees.

The horizontal component (representing the forward pulling force) that occurs when the pylons with nacelles and propellers turn forward accelerates the vehicle, which is accompanied by the development of aerodynamic lift on the wing.

Consequently, from a certain moment (corresponding to a certain angle of rotation of pylons), the total lift force of the propellers (meaning the vertical component of their thrust) and the wing becomes excessive (I.e., exceeding the weight of the vehicle), which requires a simultaneous gradual decrease in the input power and, accordingly, the thrust of the propellers coordinated with the angles of rotation of the propulsion system (comprising pylons, nacelles and propellers) around the axes of rotation of pylons. This process can be accompanied by changing the pitch of propellers.

Switching the vehicle from flight mode to hover mode (until the complete cessation of forward movement) occurs in the reverse order with the possibility of braking by means of deflection of the propeller axes at some angle back, which involves turning the pylons with nacelles from a horizontal flight position back at the angle of more than 90 degrees. It is expedient to place such a propulsion system in the upper part of the vehicle, which should ensure that the propeller blades do not protrude downwards beyond the wing and thus do not prevent the wing from descending into the effective range of altitudes corresponding to the ground effect, the propellers can turn freely around the axes of pylons to change the mode of operation, and that, in addition, it improves reliability of such propulsion being removed as far as possible from accidental debris and spraying.

Thus, the rational embodiment of the described above Wing-In-Ground Effect vehicle with vertical takeoff and landing capabilities assumes that its wing and propulsion units are separated and spaced vertically and horizontally so that a “clean” propulsion-free wing is located in the lowermost part of the vehicle (at the bottom of fuselage), and four propulsion units are mounted in the upper part at the level of the roof of the fuselage, and the two front propulsion units would be in front, and the rear two—behind the wing, so that the projections of the propulsion units and the wing onto the horizontal plane would not overlap.

The efficiency of the propeller system of the vehicle of the above design in flight mode can be increased if forward and aft propellers of each side of the vehicle are made coaxial and counter-rotating, as well as to eliminate the imbalance, the opposite rotation of the port and starboard propellers for the two forward and two aft pylons should be provided.

In the case of installing one propeller at each front and rear ends of each nacelle, in order to improve efficiency these two propellers ought to be made counter-rotating as well.

At the same time, in order to increase the efficiency of the rudders, reduce their required dimensions and, accordingly, reduce parasitic resistance and increase the efficiency of the vehicle, it is expedient to position two vertical fins with rudders in the wakes of the above coaxial propellers of each side.

In this case, each of said two vertical fins with rudders can be installed on each corresponding half-planes of the tail stabilizer.

It may be found necessary to provide the substantially horizontal tail stabilizer with a small dihedral (of the order of 5 to 15 degrees), which may be due to the features of the flow or for some increase in directional stability.

In this case, said two vertical fins with rudders, for structural reasons, can be installed normally to the planes of the tail stabilizer, that is, they will be inclined to the vertical by 5 to 15 degrees.

To enhance the effectiveness of the tail stabilizer, it can be swept back. This measure makes it possible to increase the “volume” of the stabilizer (that is, the product of its area by the distance of the resulting aerodynamic force from the vehicle's center of gravity) without enlarging the area (and, accordingly, frictional resistance) of the stabilizer and the length of the fuselage.

In the same way, by means of arrangement of the two fins with rudders on the half-planes of the swept back tail stabilizer and providing the fins with rudders with their own sweeping back, the “volume” and efficiency of the fins with rudders can also be increased without enlarging the area (and, accordingly, frictional resistance).

The configuration with one vertical fin with rudder centered in the tail atop the fuselage can simplify the structural design, but will lose to the above embodiment with two fins and rudders in “volume” and efficiency (with the same area), or will require a larger area for the same “volume” and efficiency (with corresponding increase in parasitic drag), which will also negatively affect the efficiency of the vehicle generally.

One of the possible problems of providing the vehicle with the capability of vertical takeoff and landing, and, in particular, in the case of assumed 4-pylon arrangement, is the mechanical complexity of transferring power to the propulsion system, which should ensure horizontal thrust in the flight mode and vertical thrust in takeoff, landing and hover modes.

In this regard, an expedient solution would first of all be the power plant of such VTOL WIG based on electric drive motors, which would have no problems with the supply of electrical power for any rational arrangement of motors, which could be positioned in the nacelles and drive propellers directly without any complex mechanical drive-trains.

In such configurations, each nacelle could contain one electric motor driving one propeller located at the front or rear end of the nacelle, or two electric motors one of which drives the front propeller and the other one drives the rear propeller. As an alternative, each of electric motors with a proper gear could drive counter-rotating propellers.

The use of electric motors as the power plant of such VTOL WIG makes it possible to effectively balance and control the position of the vehicle in hover mode by redistributing electric power between the nacelles, which leads to a change in the vertical thrusts of the propellers on opposite sides of the center of gravity of the vehicle and generation of the required tilting or restoring moments.

Supply of electric power for electric motors can be carried out from electric batteries located in the bottom of the fuselage, or from a hybrid system including a generator set driven by internal combustion engines (diesel engines or gas turbines, e.g., located in the aft fuselage) and a buffer battery of small capacity.

Although more complex, the latter, the hybrid option, can provide significantly greater endurance and flight range while maintaining purely electric (batteries-backed only) takeoff and landing.

This type of sea-going EVTOL WIG, which combines the highest possible aerodynamic efficiency provided by the optimal wing arrangement for the ground effect, and vertical takeoff and landing, eliminating all problems associated with hydrodynamic impacts and thus not dependent on sea conditions for this, can, as it was mentioned, take off from and land to the ground and, if properly operated on sea routes, may never touch water in its entire life cycle.

However, operation on sea routes should presuppose the possibility of an emergency landing on water at high speed in case of, for example, equipment failure, discharge of the battery supplying the propulsion electric motors, etc.

This circumstance makes it necessary that such EVTOL WIG be equipped with an emergency high-speed water landing system, which may include retractable hydroskis capable of providing relatively soft contact with water at high speed of the vehicle and stable planing with a decrease in speed until the vehicle stops afloat.

Such an emergency water landing system may comprise, for example, three retractable hydroskis installed flush with the surfaces of the bottom of the fuselage and bottom surfaces of internal horizontal sections of the wing, which hydroskis, in the event of an emergency landing on water, can extend down below the level of the bottom of the fuselage and wing, forming a three-point planing system with two symmetrical relative to the vertical longitudinal plane of symmetry of the vehicle planing surfaces on one side of the center of gravity in the longitudinal direction and one central planing surface on the other side of the center of gravity in the longitudinal direction, which ensures stable skimming of the vehicle when landing on water at high speed.

According to the same principle of symmetry with respect to the longitudinal vertical plane of symmetry of the vehicle and the location of the planing surfaces in front of and behind the center of gravity, the emergency water landing system can consist of four or more retractable hydroskis.

To ensure or increase maneuverability both during flight and in the hover mode during takeoff and landing, the EVTOL WIG vehicle can be equipped with additional control aerodynamic surfaces in the form of turnable vanes installed in the wakes of the propellers and normal to the axes of rotation of both the propellers and corresponding pylons.

Simultaneous turning such vanes in the wake of propellers in the same direction creates a lateral force that can move the vehicle sideways and to turn on the spot (in the hovering mode) when turning such vanes on the forward and aft nacelles in opposite directions, the ability of which, combined with the ability to deflect the nacelles in a vertical position and regulate the thrust of propellers, allows full three-dimensional control of the position of the vehicle.

Such an aerodynamic control surface can also be made in the form of a fin with a rudder.

In addition, the vehicle can be equipped with a landing gear used for landing on solid ground, which landing gear can include three sprung wheels designed to soften contact with the ground during landing and allow the vehicle to be rolled away on the ground (for charging and maintenance, e.g.).

To realize these purposes, the wheels of such a landing gear, of course, must be located under the bottom of the vehicle, holding the vehicle at a certain height above the ground and thus must extend to somewhat downward.

However, to enable the wing to operate in the ground effect mode at optimally low altitudes, the landing gear wheels in flight must not protrude below the bottom surface of the wing that necessitates making the landing gear wheels retractable.

Correspondingly, the purpose of this invention is to provide the optimum configuration of an aerial vehicle employing the Wing-In-Ground effect technology and being capable to take off and land vertically that would eliminate the problems of hydrodynamic impacts and this way enable to realize all the great potential efficiency of the aerial vehicles based on the WIG technology in excess of the efficiency of aircraft by means of the optimum ultimately low position of the propulsion-free wing, while spacing from the wing and arranging propulsion at the safe uppermost part of the fuselage, avoiding power transmission problems with employment of electric power and guaranteeing smooth emergency landing on water by means of retractable hydroskis.

### SUMMARY OF THE INVENTION

The EVTOL WIG vehicle following the present invention comprises an elongated fuselage, a wing with its half-planes extending outwardly both sides of the fuselage, a substantially horizontal tail stabilizer and at least one vertical fin with rudder located at the utmost aft part of the vehicle, four non-lift-generating rotatable pylons extending transversely in pairs on both sides of the upper part of the fuselage and both sides of the center of gravity of the vehicle lengthwise, four elongated nacelles mounted on the outer tips of said four rotatable pylons, which nacelles contain electric motors and provided with propellers at their extremities, so that rotation of pylons results in turning the nacelles and thrust of propellers from substantially vertical, ensuring take-off and landing, to substantially horizontal ensuring flight mode, at least three retractable hydroskis for emergency landing on water, while to secure propellers against damages and not hamper the wing to get into the optimum ground effect said pylons with nacelles are arranged at the top of the fuselage, and, owing to the vertical takeoff and landing, said separated from propulsion wing arranged at the lowermost bottom part of the fuselage, so that the wing and propulsion units are spaced vertically and horizontally, meaning that the projections of the propulsion units on the transverse plane arrange higher than the projection of the wing, and the projections of the propulsion units and the wing on the horizontal plane do not overlap, which configuration makes it possible to fully realize the potential efficiency of the concept employing the Wing-in-Ground Effect in excess of the efficiency of aircraft.

Various embodiments are disclosed herein for an aerial vehicle employing the concept of the Wing-in-Ground Effect (WIG) being capable to take-off and land vertically (VTOL) and, in particular, WIG propelled by electric motors (E), which combination of technologies provides resulting EVTOL WIG with new operational capabilities, elimination of problems of WIGs with conventional takeoff and landing, and realization of the full potential efficiency of the WIG technology.

In some embodiments each of the half-planes of the wing consists of a substantially horizontal inner section and a positively inclined outer section with the height from said lowermost basic horizontal plane of the vehicle increasing towards the tip of the wing.

In some embodiments the outer end sections of the wing are made with a broken configuration in the projection on the transverse plane providing that tip portions of said positively inclined outer sections of the wing are made bent down.

In some embodiments said two substantially horizontal inner sections of half-planes of the wing are made swept forward so that outer sections of said inner sections of half-planes arranged upstream of the adjacent to the fuselage root sections.

In some embodiments planes of rotation of the axes of propellers caused by rotation of the front and rear pylons of one side are made coplanar.

In some embodiments the horizontal in the flight mode axes of the propellers of the front and rear pylons of one side are made coaxial.

In some embodiments propellers of transversely opposed pylons are made counter-rotating.

In some embodiments each elongated relatively the axis of propeller nacelle is provided with one propeller at one of its lengthwise ends and propellers of the front and rear pylons of one side are made counter-rotating.

In some embodiments each elongated relatively the axis of propeller nacelle is provided with two counter-rotating propeller at one of its lengthwise ends.

In some embodiments each elongated relatively the axis of propeller nacelle is provided with one propeller at each of its lengthwise ends and these propellers of each nacelle are made counter-rotating.

In some embodiments each nacelle contains one electric motor with its driving shaft facing forward and driving one propeller at the front end of said nacelle, or with its driving shaft facing aft and driving one propeller at the rear end of said nacelle.

In some embodiments each nacelle contains one electric motor with its driving shaft facing forward and driving one propeller at the front end of said nacelle, and one electric motor with its driving shaft facing aft and driving one propeller at the rear end of said nacelle.

In some embodiments each nacelle contains one electric motor driving counter-rotating propellers at one of the ends of said nacelle.

In some embodiments said propulsion electric motors are powered by a hybrid power-supplying system containing at least one electric power generation set, consisting of an internal combustion engine or turbine driving a generator, and an electric buffer battery recharged by said electric power generation set and supplying electric power to said propulsion electric motors.

In some embodiments the lengthwise utmost aft part of the vehicle is provided with two vertical fins with rudders each mounted on each of half-planes of horizontal tail stabilizer and each of said two vertical fins with rudders is arranged in the wake of propellers of one side of the vehicle.

In some embodiments said EVTOL WIG vehicle is provided with at least two hydroskis arranged symmetrically both sides of the vertical longitudinal plane with their hydrodynamic lift generating surfaces in the horizontal projection displaced in the longitudinal direction from the center of gravity and hydrodynamic lift generating surface of at least one symmetrical relatively said vertical longitudinal plane hydroski is displaced in the horizontal projection lengthwise relative the center of gravity in the opposite direction.

In some embodiments said hydroskis are provided with shock absorbers.

In some embodiments each of nacelles is provided with at least one aerodynamic control vane positioned in the wake of nacelle's propeller, which vane is arranged substantially normally to the axis of the propeller and the axis of rotation of corresponding pylon, and turnable around the axis being substantially normal to said axis of the propeller and the axis of rotation of corresponding pylon.

In some embodiments said aerodynamic control vane represents the aft rudder part of a fin positioned in the wake of nacelle's propeller, which fin arranged substantially normally to the axis of the propeller and the axis of rotation of corresponding pylon. In some embodiments said EVTOL WIG vehicle is provided with a landing gear comprising at least three sprung retractable wheels.

### BRIEF DESCRIPTION OF DRAWINGS

The accompanying drawings, which are incorporated herein and constitute part of this specification, illustrate exemplary embodiments, and together with the general description given above and the detailed description given below, serve to explain the features of the various embodiments.

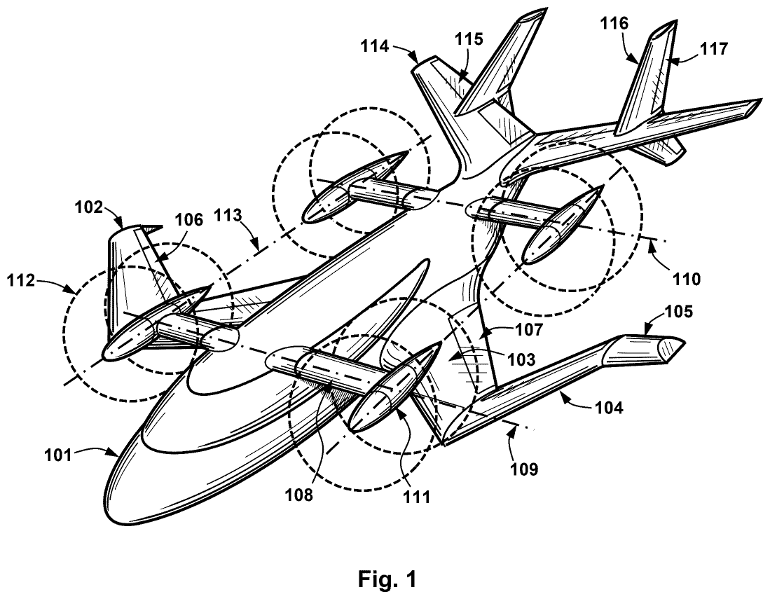

FIG. 1 is a schematic diagram that illustrates a front top perspective view of an EVTOL WIG aerial vehicle employing the concept of the Wing-in-Ground Effect (WIGs), being capable to take-off and land vertically (VTOL) and propelled by electric motors (E) according to some embodiments in which the aerial vehicle is shown in the flight mode.

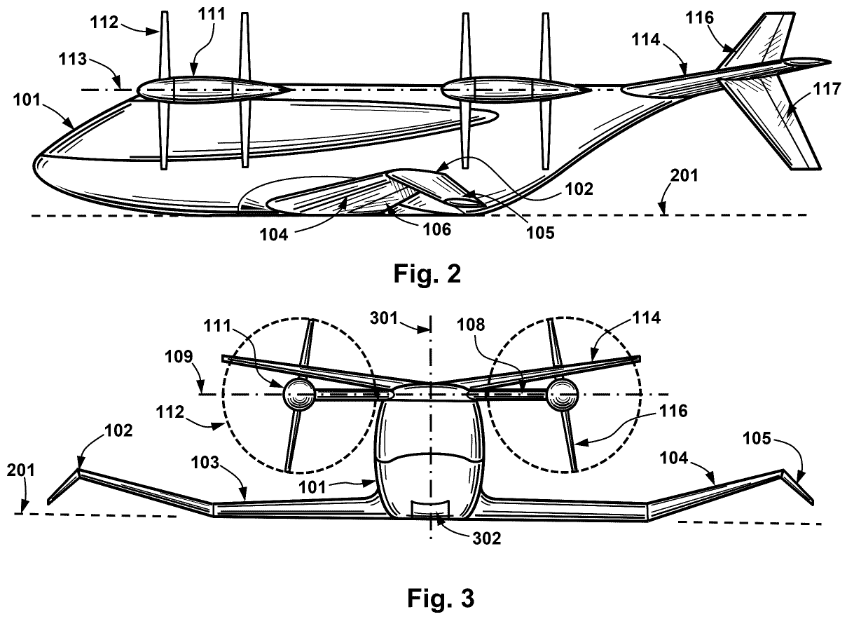

FIG. 2 depicts a schematic diagram illustrating the side elevation view of a vehicle according to some embodiments and basically corresponding to the embodiment of the FIG. 1.

FIG. 3 depicts a schematic diagram illustrating the front elevation view of a vehicle according to some embodiments and basically corresponding to the embodiment of the FIG. 1.

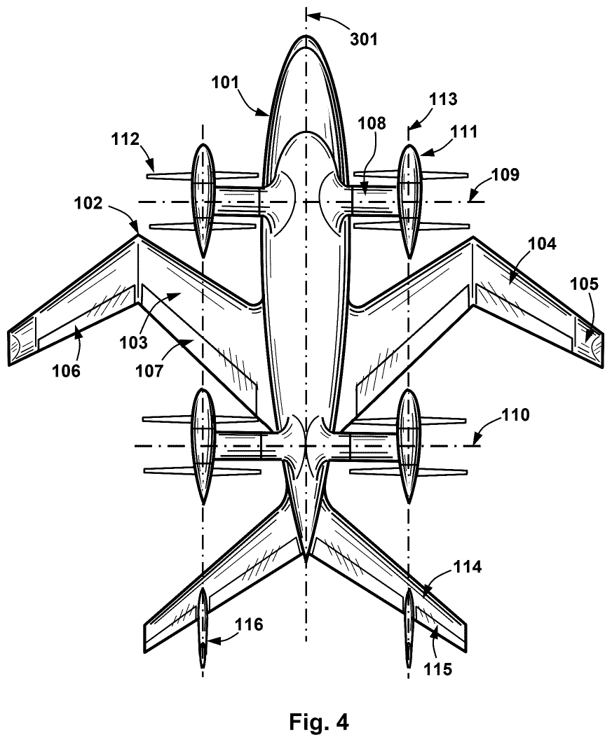

FIG. 4 depicts a schematic diagram illustrating the plan view of a vehicle according to some embodiments and basically corresponding to the embodiment of the FIG. 1.

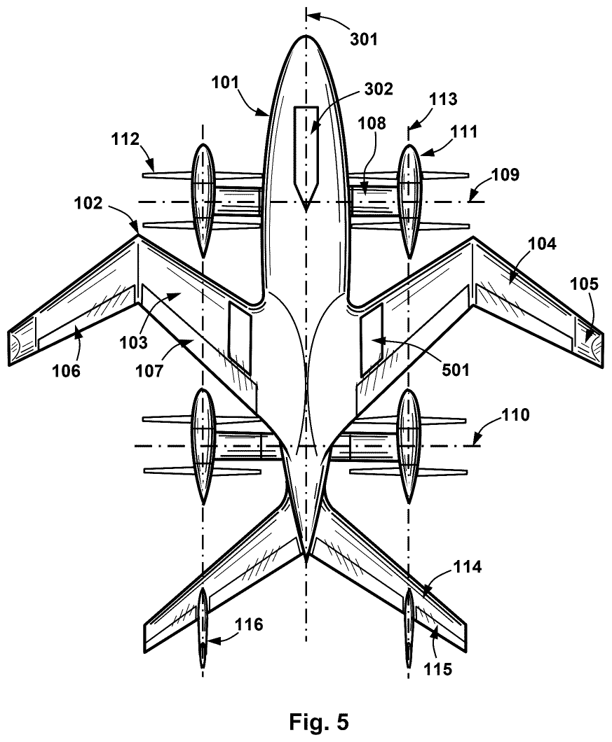

FIG. 5 depicts a schematic diagram illustrating the bottom view of a vehicle according to some embodiments and basically corresponding to the embodiment of the FIG. 1.

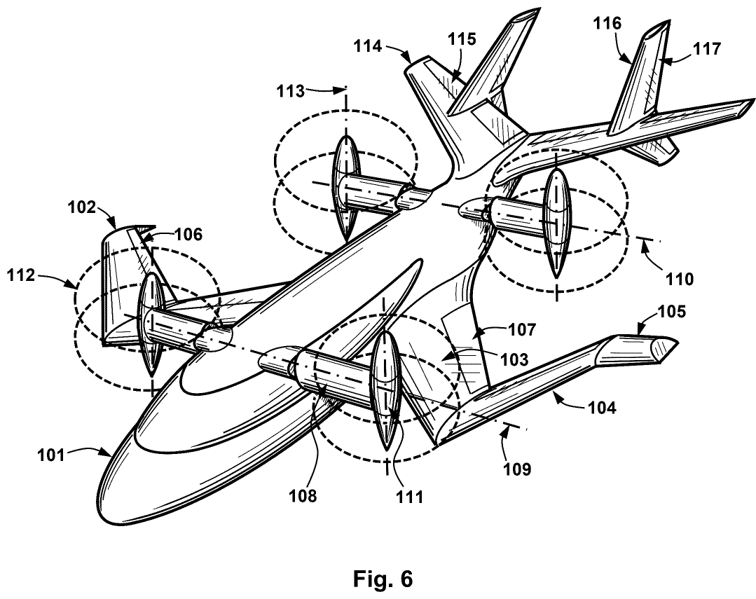

FIG. 6 is a schematic diagram that illustrates a front top perspective view of an EVTOL WIG aerial vehicle employing the concept of the Wing-in-Ground Effect (WIGs), being capable to take-off and land vertically (VTOL) and propelled by electric motors (E) according to some embodiments and basically corresponding to the embodiment of the FIG. 1, but in which the aerial vehicle is shown in the take-off, landing and hovering mode.

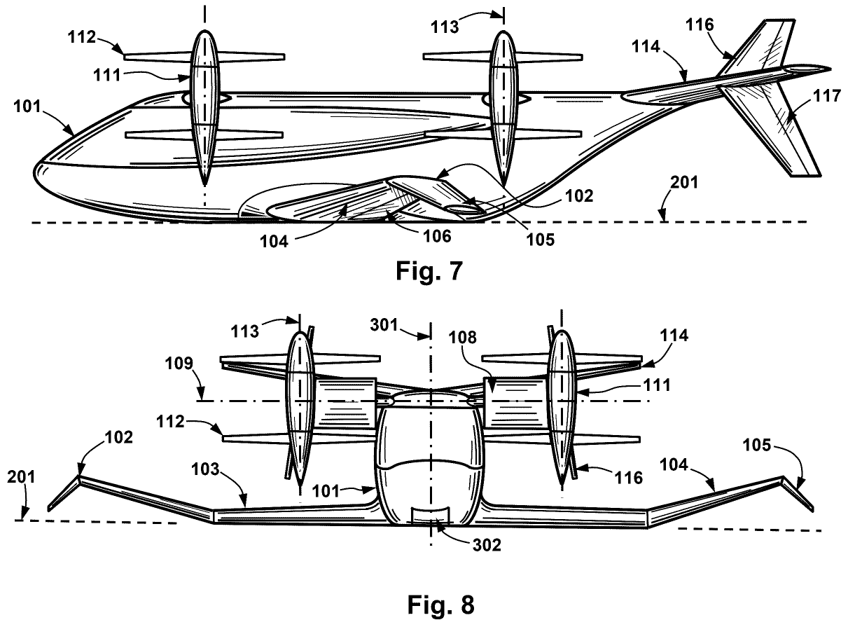

FIG. 7 depicts a schematic diagram illustrating the side elevation view of a vehicle according to some embodiments and basically corresponding to the embodiment of the FIG. 6.

FIG. 8 depicts a schematic diagram illustrating the front elevation view of a vehicle according to some embodiments and basically corresponding to the embodiment of the FIG. 6.

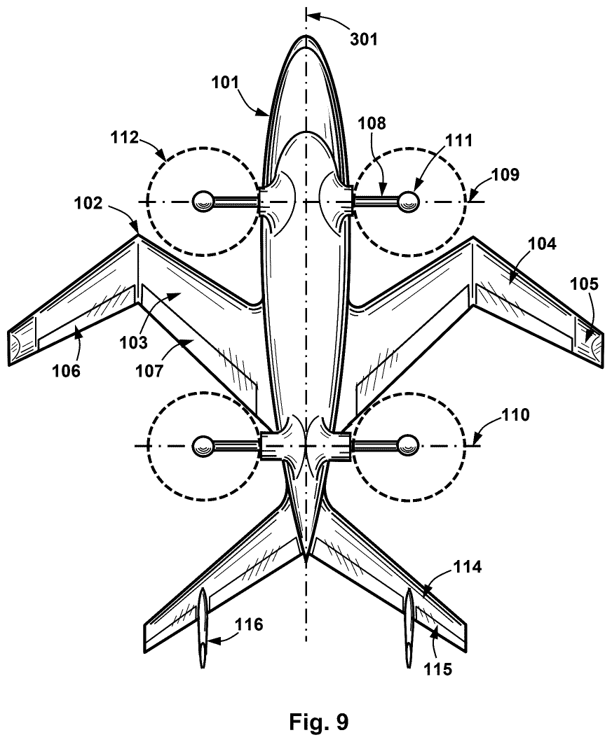

FIG. 9 depicts a schematic diagram illustrating the plan view of a vehicle according to some embodiments and basically corresponding to the embodiment of the FIG. 6.

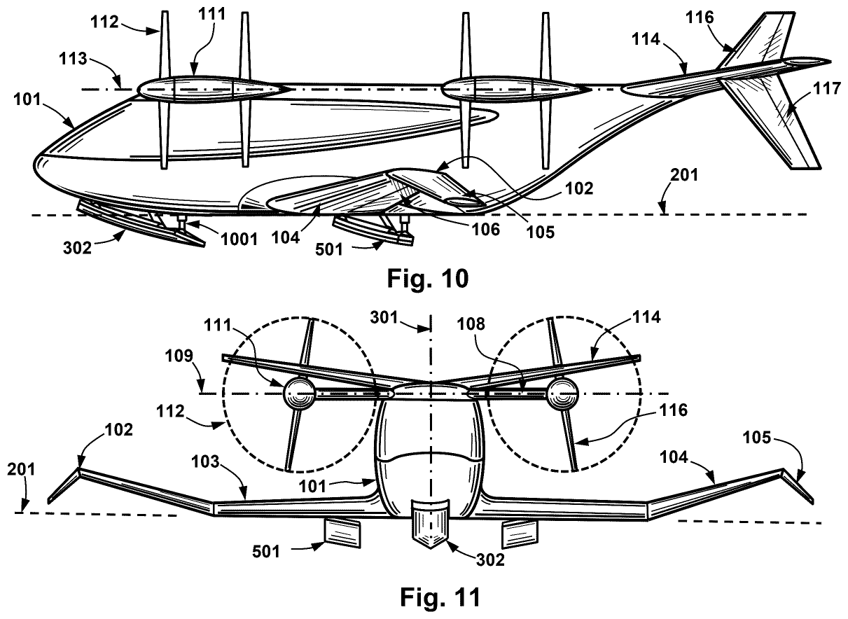

FIG. 10 depicts a schematic diagram illustrating the side elevation view of a vehicle according to some embodiments and basically corresponding to the embodiment of the FIG. 1, wherein the EVTOL WIG vehicle is shown in the mode corresponding emergency landing on water.

FIG. 11 depicts a schematic diagram illustrating the front elevation view of a vehicle according to some embodiments and basically corresponding to the embodiment of the FIG. 1, wherein the EVTOL WIG vehicle shown in the mode corresponding emergency landing on water.

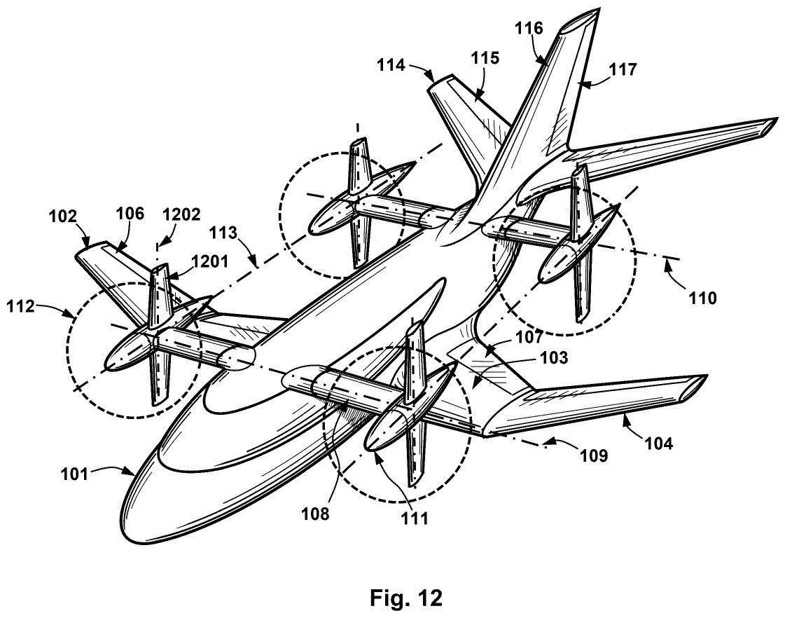

FIG. 12 depicts a schematic diagram illustrating a front top perspective view of one of possible embodiments of the EVTOL WIG aerial vehicle employing the concept of the Wing-in-Ground Effect (WIG), being capable to take-off and land vertically (VTOL), propelled by electric motors (E) and shown in the flight mode, while, unlike the embodiment of FIG. 1, featuring a straight (not swept) wing without bent tips, nacelles each provided with only one propeller and one electric motor, only one central vertical fin with rudder at the tail and aerodynamic control vanes.

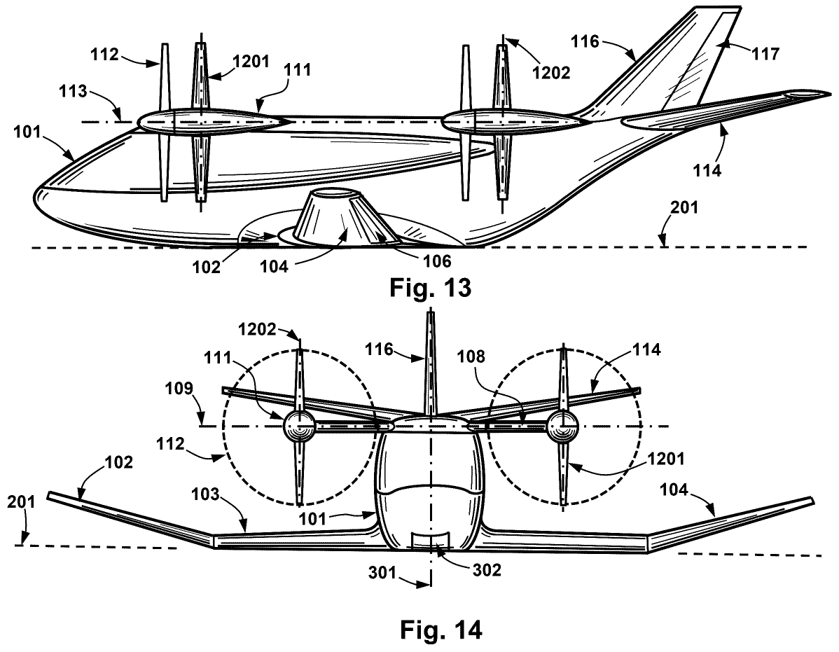

FIG. 13 depicts a schematic diagram illustrating the side elevation view of a vehicle according to some embodiments and basically corresponding to the embodiment of the FIG. 12.

FIG. 14 depicts a schematic diagram illustrating the front elevation view of a vehicle according to some embodiments and basically corresponding to the embodiment of the FIG. 12.

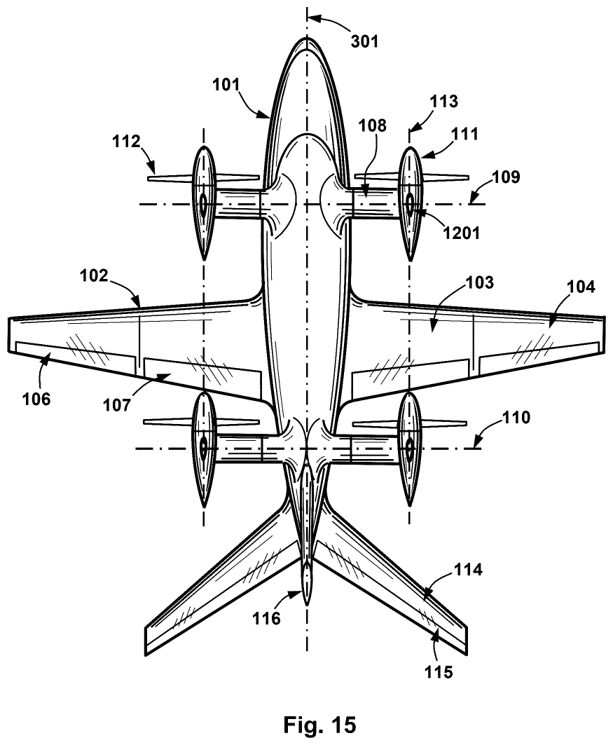

FIG. 15 depicts a schematic diagram illustrating the plan view of a vehicle according to some embodiments and basically corresponding to the embodiment of the FIG. 12.

### DETAILED DESCRIPTION OF THE INVENTION

Various embodiments will be described in detail with reference to the accompanying drawings. Wherever possible, the same reference will be used throughout the drawings to refer to the same or like parts. References made to particular examples and implementations are for illustrative purposes, and are not intended to limit the scope of the claims.

FIG. 1 is a schematic diagram that illustrates a front top perspective view of an EVTOL WIG aerial vehicle employing the concept of the Wing-in-Ground Effect (WIGs), being capable to take-off and land vertically (VTOL) and propelled by electric motors (E) according to some embodiments in which the aerial vehicle is shown in the flight mode and comprises a fuselage 101 elongated in the direction of flight and a wing 102 located at the lowermost bottom part of the fuselage 101, while two symmetrical half-planes of said wing 102 extend outwardly on both sides of the fuselage 101.

So that in the principal flight mode of operation said wing 102 generates an aerodynamic lift with a resultant force located at about the center of gravity of the vehicle in horizontal projection, which aerodynamic lift supports the vehicle in its flight mode, whereas the lowermost location of the wing makes it possible to fully realize the potential efficiency of the WIG concept in excess of the efficiency of conventional aircraft.

The wing 102 consists of substantially horizontal swept forward inner (nearer to the fuselage 101) sections 103 and positively inclined outer section 104 with the height increasing towards the tip of the wing, while tip portions 105 of said positively inclined outer sections of the wing made bent down.

The substantially horizontal position of the inner sections 103 makes better use of the ground effect. While the reverse sweep of these sections endows such a wing with a certain self-stabilization in pitch. Both of these factors have a positive effect on the aerodynamic efficiency of the vehicle through an increase in lift and a decrease in air resistance.

Positively sloping outer sections 104 allow the vehicle to make banked turns at low altitudes corresponding the ground effect, while the broken down configuration of the outer end sections 105 of the wing 102 reduces the inductive drag of the wing 102 and increases the lift of the end sections 105, which, thereby, leads to an increase in efficiency of the vehicle, whereas the steep slope of the end sections 105 avoids slamming in case of accidental contact with water.

To regulate the lift of this main wing and ensure a proper roll control of the vehicle as an aerial one the wing 102 provided with ailerons 106 and flaps 107.

In order to ensure the vertical takeoff and landing, said vehicle is provided with a propulsion system with a turnable thrust vector, which system comprises four non-lift-generating rotatable pylons 108 protruding transversely and substantially horizontally in pairs on both sides of the upper part of the fuselage 101 and forming front and rear coaxial pairs of pylons with axes of rotation 109 and 110 substantially normal to the vertical longitudinal plane of symmetry of the vehicle, so that the axis of rotation of the front pair 109 is located in front, and the rear 110—behind said center of gravity of the vehicle lengthwise, and four nacelles 111 containing presumably two electric motors and provided with propellers 112 (conditionally shown by the contours of the disks of their rotation) at each of lengthwise ends of nacelles 111, which nacelles 111 mounted on the outer tips of said four rotatable pylons 108 with axes of rotation of said propellers 113 being normal to the axes of rotation of said pylons 109 and 110, so that rotation of pylons 108 results in turning the nacelles 111 and the axes 113 of propellers 112 in the vertical longitudinal plane.

It is assumed that one—the front—of the electric motors in each nacelle 111 is mounted with a drive shaft pointing forward and rotates the front propeller 112. And, accordingly, the second-rear-electric motor is installed with the drive shaft looking back and rotates the rear propeller 112 of this nacelle.

The top location of the pylons 108, nacelles 111 and propellers 112 removes them from the zone of the most probable damage from accidental debris and spraying and, thereby, increases the durability of the propulsion system, and, moreover, does not prevent the wing 102 from descending into the optimal and most economical ground effect flight mode.

All of them: pylons 108, nacelles 111, propellers 112 with their axles 113 are shown in the flight mode assuming horizontal thrust and, accordingly, the horizontal position of the pylons 108, the nacelles 111 and axles 113, while axes of the propellers 112 of the front and rear pylons 108 of each side of the vehicle made coaxial and the planes of their rotation due to rotation of pylons 108 are coplanar, presupposing that propellers at the ends of each nacelle and propellers of transversely opposed pylons are counter-rotating.

In this embodiment the vehicle is provided with substantially horizontal swept back tail stabilizer 114 made with a slight dihedral and equipped with conventional for aerial vehicles elevators 115 intended to govern pitch of the vehicle.

The sweep back of the tail stabilizer 114 makes it possible to enhance its “volume” and efficiency without increasing its area and fuselage length.

Because of the swept forward configuration the inner horizontal sections 103 of the wing 102 providing certain self-stabilization effect, the tail stabilizer 114 can be made of smaller dimensions and area. That reduces parasitic drag and increases the efficiency of the vehicle.

For directional control the vehicle is equipped with two substantially vertical fins 116 with rudders 117 mounted on each of half-planes of the tail stabilizer 114, while to enhance effectiveness of the directional control surfaces each of said two vertical fins 116 with rudders 117 arranged in the wake of propellers 112 of one side of the vehicle. In order to further improve effectiveness, the vertical fins 116 with rudders 117 made swept back, which configuration increases the “volume” without enlarging their area and elongating the fuselage 101.

Taking into account the dihedral of the tail stabilizer 114, to simplify the structural design fins 116 with rudders 117 mounted normally to the planes of the stabilizer 114 have some inclination inward.

Thus, taking into consideration the above, the shown embodiment allows fully realizing all the potential efficiency of the WIG concept and, ceteris paribus, ensuring aerodynamic efficiency exceeding efficiency of conventional aircraft.

FIG. 2 depicts a schematic diagram illustrating the side elevation view of a vehicle according to some embodiments and basically corresponding to the embodiment of the FIG. 1, wherein the EVTOL WIG vehicle is shown in the flight mode and comprises: a fuselage 101 and a wing 102 located at the lowermost bottom part of the fuselage and shown by its positively inclined section 104 with its aileron 106 and bent down tip section 105.

Two consecutive-front and rear-nacelles 111 of each side of the vehicle, each of which is equipped with a front and rear counter-rotating propellers 112, are located in the upper part of the vehicle at the level of the roof of the fuselage 101 and higher than the wing 102.

In the shown flight mode the propellers 112 of the front and rear nacelles 111 of each side of the vehicle are coaxial with their common axis of rotation 113.

The tail section of the vehicle is equipped with a substantially horizontal and slightly dihedral swept back stabilizer 114 and two vertical fins 116 with rudders 117 (the fin 116 and rudder 117 of only one side are visible in this side elevation view).

The diagram also depicts the basic lowermost plane 201 of the vehicle.

The location of the wing 102 directly on and adjacent to the plane 201 allows it to be as close as possible to the surface of the ground or water and, thereby, to maximize the ground effect and the efficiency of the vehicle.

At the same time, the nacelles 111 with propellers 112 are arranged as far as possible from the basic lowermost plane 201 and, accordingly, from sources of debris and spraying.

With this top arrangement, the propellers 112 do not protrude downward from plane 201 and thereby allow the wing 102 to operate at an optimally close distance from the ground or water surface, fully implementing the ground effect and maximizing the efficiency of the vehicle.

FIG. 3 depicts a schematic diagram illustrating the front elevation view of a vehicle according to some embodiments and basically corresponding to the embodiment of the FIG. 1, where two lowermost positioned half-planes of the wing 102 extend both sides of the fuselage 101 symmetrically relatively the vertical longitudinal plane of symmetry 301 and comprise horizontal inner sections 103 being adjacent to the basic lowermost plane 201 of the vehicle, outwardly elevating sections 104 and bent down tip sections 105. The uppermost part of the fuselage 101 is provided with pylons 108 capable of turning about an axis 109 (corresponding to the forward pair of pylons 108 visible in this front elevation view).

Nacelles 111 with propellers 112 are mounted on the outer tips of the pylons 108 and thus can rotate with the rotation of the pylons 108 around the axis 109.

Thus, the wing 102 is located in the most favorable position for the implementation of the ground effect, and the pylons 108 with nacelles 111 and propellers 112 are removed to the greatest distance from the base plane 201 and the wing 102, which increases the survivability of the propulsion system and does not prevent the wing 102 from effectively implementing the ground effect.

The substantially horizontal and slightly dihedral tail stabilizer 114 is also located in the upper part of the fuselage 101.

Two vertical fins 116 (slightly inclined due to the dihedral of the tail stabilizer 114) are mounted one on each of the half-planes of the tail stabilizer 114 in the wakes of the propellers 112, which increases the effectiveness of the directional controls.

The forward bottom part of the fuselage 101 is equipped with a retractable hydroski 302 depicted for the shown flight mode in the retracted position.

FIG. 4 depicts a schematic diagram illustrating the plan view of a vehicle according to some embodiments and basically corresponding to the embodiment of the FIG. 1, where the symmetrical relatively the vertical longitudinal plane of symmetry 301 EVTOL WIG vehicle is shown in the flight mode and comprises a fuselage 101 and wing 102, which half-planes extend both sides of the fuselage 101 and include swept forward inner sections 103 with their flaps 107, swept back sections 104 with their ailerons 106 and swept back bent down tip sections 105.

Two pairs of turnable front and rear pylons 108 with their axes of rotation 109 and 110 protrude transversally and normally to the plane 301 both sides of the fuselage 101, while the forward axis of rotation 109 supposed to be arranged in front of the center of gravity of the vehicle and the aft axis of rotation 110—behind the center of gravity of the vehicle lengthwise.

Nacelles 111 each with front and rear counter-rotating propellers 112 are mounted at the tips of the pylons 108 and thus rotate with the rotation of the pylons 108 around the axes 109 and 110, while the two forward propulsion units arrange in front of the wing 102 and the two aft propulsion units—behind the wing 102 lengthwise not overlapping the wing 102.

The propellers 112 of the front and rear nacelles 111 of each side of the vehicle are coaxial with their common axis of rotation 113.

It is presupposed that each nacelle contains two electric motors: one—the front—of the electric motors is mounted with a drive shaft pointing forward and rotates the front propeller 112. And, accordingly, the second-rear-electric motor is installed with the drive shaft looking back and rotates the rear propeller 112 of this nacelle.

The tail section of the vehicle features a swept back stabilizer 114 with its elevators 115 and two vertical fins 116 mounted each on each of half-planes of the tail stabilizer 114 in the wakes of propellers 112 of corresponding sides of the vehicle.

The swept forward configuration of the inner sections 103 of the wing 102 provides a certain self-stabilizing effect in pitch, which allows the area of the tail stabilizer 114 to be reduced, thereby reducing aerodynamic drag and increasing the vehicle's efficiency. FIG. 5 depicts a schematic diagram illustrating the bottom view of a vehicle according to some embodiments and basically corresponding to the embodiment of the FIG. 1, where the symmetrical relatively the vertical longitudinal plane of symmetry 301 EVTOL WIG vehicle is shown in the flight mode and comprises a fuselage 101 and wing 102, which half-planes extend both sides of the fuselage 101 and include swept forward inner sections 103 with their flaps 107, swept back sections 104 with their ailerons 106 and swept back bent down tip sections 105.

Two pairs of turnable front and rear pylons 108 with their axes of rotation 109 and 110 protrude transversally and normally to the plane 301 both sides of the fuselage 101 and assumably both sides of the center of gravity of the vehicle lengthwise.

Nacelles 111 each with front and rear counter-rotating propellers 112 are mounted at the tips of the pylons 108 and thus rotate with the rotation of the pylons 108 around the axes 109 and 110, while the two forward propulsion units arrange in front of the wing 102 and the two aft propulsion units—behind the wing 102 lengthwise not overlapping the wing 102.

The propellers 112 of the front and rear nacelles 111 of each side of the vehicle are coaxial with their common axis of rotation 113.

It is presupposed that each nacelle contains two electric motors: one—the front—of the electric motors is mounted with a drive shaft pointing forward and rotates the front propeller 112. And, accordingly, the second-rear-electric motor is installed with the drive shaft looking back and rotates the rear propeller 112 of this nacelle.

The tail section of the vehicle features a swept back stabilizer 114 with its elevators 115 and two vertical fins 116 mounted each on each of half-planes of the tail stabilizer 114 in the wakes of propellers 112 of corresponding sides of the vehicle.

The swept forward configuration of the inner sections 103 of the wing 102 provides a certain self-stabilizing effect in pitch, which allows the area of the tail stabilizer 114 to be reduced, thereby reducing aerodynamic drag and increasing the vehicle's efficiency.

This bottom view of the vehicle depicts arrangement of hydroskis intended for emergency landing on water. This emergency landing system comprises one centrally positioned forward hydroski 302 and two aft hydroskis 501 symmetrically spaced at some distance from the plane of symmetry 301 and mounted in a retracted position flush in the bottom surfaces of the inner horizontal sections 103 of the wing 102. The location of hydro-skis implies that during the period of skimming along the surface of the water upon landing, the resulting hydrodynamic lifting force of the released and planing front hydro-ski 302 should be in front of the center of gravity of the vehicle, and the resulting hydrodynamic lifting force of the released and planing two rear hydroskis 501—behind the center of gravity lengthwise, which three-point planing hydrodynamic system ensures stable skimming of the vehicle when landing on water at high speed.

FIG. 6 is a schematic diagram that illustrates a front top perspective view of an EVTOL WIG aerial vehicle employing the concept of the Wing-in-Ground Effect (WIGs), being capable to take-off and land vertically (VTOL) and propelled by electric motors (E) according to some embodiments and basically corresponding to the embodiment of the FIG. 1, but in which the aerial vehicle is shown in the take-off, landing and hovering mode.

In this diagram the vehicle comprises a fuselage 101 elongated in the direction of flight and a wing 102 located at the lowermost bottom part of the fuselage, while two symmetrical half-planes of said wing extend outwardly on both sides of the fuselage.

The wing 102 consists of substantially horizontal swept forward inner (nearer to the fuselage 101) sections 103 with their flaps 107, positively inclined outer sections 104 with their ailerons 106 and tip portions 105 of the outer sections of the wing made bent down.

In this embodiment the vehicle is provided with substantially horizontal swept back tail stabilizer 114 made with a slight dihedral and equipped with conventional for aerial vehicles elevators 115, and two substantially vertical fins 116 with rudders 117 mounted on each of half-planes of the tail stabilizer 114.

In order to ensure the vertical takeoff and landing, the vehicle is provided with a propulsion system with a turnable thrust vector, which system comprises four rotatable pylons 108 protruding transversely and substantially horizontally in pairs on both sides of the upper part of the fuselage 101 and forming front and rear coaxial pairs of pylons with axes of rotation 109 and 110 substantially normal to the vertical longitudinal plane of symmetry of the vehicle, so that the axis of rotation of the front pair 109 is located in front, and the rear 110—behind said center of gravity of the vehicle lengthwise, and four nacelles 111 each containing presumably two electric motors driving propellers 112 (conditionally shown by the contours of the disks of their rotation) at each of ends of nacelles 111, which nacelles 111 are elongated along the axes of rotation 113 of the propellers 112 and mounted on the outer tips of said four rotatable pylons 108, while axes of rotation 113 of the propellers 112 made normal to the axes of rotation of the pylons 109 and 110.

In this diagram pylons 108, nacelles 111, propellers 112 with their axles 113 are shown in the in the take-off, landing and hovering mode assuming vertical thrust and, accordingly, the vertical position of the pylons 108, the nacelles 111 and axles 113. Correspondingly, it is assumed that in the shown mode of operation one—the upper—of the two electric motors in each nacelle 111 is mounted with a drive shaft pointing up and rotates the upper propeller 112. And, accordingly, the second-lower-electric motor is installed with the drive shaft looking down and rotates the lower propeller 112 of this nacelle.

The use of electric motors as the power plant of such VTOL WIG makes it possible to effectively balance and control the position of the vehicle in hover mode by redistributing electric power between the nacelles 111, which leads to differences in the vertical thrusts of the propellers 112 on opposite sides of the center of gravity of the vehicle and generation of the required tilting or restoring moments.

In the shown hover mode, the longitudinal movements of the vehicle forward and backward for the purpose of maneuvering can be implemented by means of a slight (by some small angle) rotation of the pylons 108 around axes 109 and 110 relative to the mainly vertical position, which results in slight tilting from the mainly vertical position of the nacelles 111 and, accordingly, the vertical axes 113 of the propellers 112 and the thrust vector of the propellers 112, leading to generation of a small longitudinal component of the thrust.

FIG. 7 depicts a schematic diagram illustrating the side elevation view of a vehicle according to some embodiments and basically corresponding to the embodiment of the FIG. 6, wherein the EVTOL WIG vehicle is shown in the take-off, landing and hovering mode and comprises: a fuselage 101 and a wing 102 located at the lowermost bottom part of the fuselage and shown by its positively inclined section 104 with it aileron 106 and bent down tip section 105.

The depicted front and rear nacelles 111 of the one side of the vehicle, each of which is equipped with counter-rotating propellers 112 with their axes 113, are located in the upper part of the vehicle.

Corresponding to the take-off, landing and hovering mode nacelles 111 and propellers 112 with their axles 113 are shown in the vertical position that ensures the vertical direction of the thrust vector required to support the vehicle at zero and low forward speeds.

The tail section of the vehicle is equipped with a substantially horizontal and slightly dihedral swept back stabilizer 114 and two vertical fins 116 with rudders 117 (the fin 116 and rudder 117 of only one side are visible in this side elevation view).

The diagram also shows the basic lowermost plane 201 of the vehicle.

The nacelles 111 with propellers 112 are arranged as far as possible from the basic lowermost plane 201 and, accordingly, from sources of debris and spraying.

FIG. 8 depicts a schematic diagram illustrating the front elevation view of a vehicle according to some embodiments and basically corresponding to the embodiment of the FIG. 6, where two lowermost positioned half-planes of the wing 102 extend both sides of the fuselage 101 symmetrically relatively the vertical longitudinal plane of symmetry 301 and comprise horizontal inner sections 103 being adjacent to the basic lowermost plane 201 of the vehicle, outwardly elevating sections 104 and bent down tip sections 105.

Pylons 108 capable of turning about an axis 109 (corresponding to the forward pair of pylons 108 visible in this front elevation view) arranged at the uppermost part of the fuselage 101, while nacelles 111 are mounted at the tips of the pylons 108 and thus can rotate with the rotation of the pylons 108 around the axis 109.

The upper and lower ends of the nacelles 111 are provided with propellers 112 with their axes 113.

Corresponding to the take-off, landing and hovering mode the pylons 108, nacelles 111 and propellers 112 with their axles 113 are shown in the vertical position that ensures the vertical direction of the thrust vector required to support the vehicle at zero and low forward speeds.

The substantially horizontal and slightly dihedral tail stabilizer 114 is also located in the upper part of the fuselage 101.

Two vertical fins 116 (slightly inclined due to the dihedral of the tail stabilizer 114) are mounted one on each of the half-planes of the tail stabilizer 114.

The forward bottom part of the fuselage 101 is equipped with a retractable hydroski 302 depicted in the retracted position.

FIG. 9 depicts a schematic diagram illustrating the plan view of a vehicle according to some embodiments and basically corresponding to the embodiment of the FIG. 6, where the symmetrical relatively the vertical longitudinal plane of symmetry 301 EVTOL WIG vehicle is shown in the take-off, landing and hovering mode and comprises a fuselage 101 and wing 102, which half-planes extend both sides of the fuselage 101 and include swept forward inner sections 103 with their flaps 107, swept back sections 104 with their ailerons 106 and swept back bent down tip sections 105.

Two pairs of turnable front and rear pylons 108 with their axes of rotation 109 and 110 protrude transversally and normally to the plane 301 both sides of the fuselage 101 and assumably both sides of the center of gravity of the vehicle lengthwise.

Nacelles 111 with propellers 112 are mounted at the tips of the pylons 108 and thus can rotate with the rotation of the pylons 108 around the axes 109 and 110, while the two forward propulsion units arrange in front of the wing 102 and the two aft propulsion units—behind the wing 102 lengthwise not overlapping the wing 102.

Due to the take-off, landing and hovering mode, the pylons 108, nacelles 111 and propellers 112 are shown in the vertical position that ensures the vertical direction of the thrust vector required to support the vehicle at zero and low forward speeds.

At the same time, to avoid efficiency-reducing aerodynamic interference of the wakes of propellers 112 with the planes of the wing 102 during shown vertical takeoff, hover, and landing modes of vehicle, projections of the front pair of propellers 112 corresponding to the axes 109 on the horizontal plane are to be in front of the projection of the wing 102 on this plane and projections of the rear pair of propellers corresponding to the axes 110 on the horizontal plane are to be behind the projection of the wing 102 on this plane.

The tail section of the vehicle features a swept back stabilizer 114 with its elevators 115 and two vertical fins 116 mounted each on each of half-planes of the tail stabilizer 114. FIG. 10 depicts a schematic diagram illustrating the side elevation view of a vehicle according to some embodiments and basically corresponding to the embodiment of the FIG. 1, wherein the EVTOL WIG vehicle is shown in the mode corresponding emergency landing on water and comprises: a fuselage 101 and a wing 102 located at the lowermost bottom part of the fuselage and shown in this side elevation view by its positively inclined section 104 with it aileron 106 and bent down tip section 105. Two consecutive-front and rear-nacelles 111 of the one side of the vehicle, each of which is equipped with a front and rear counter-rotating propellers 112, are located in the upper part of the vehicle at the level of the roof of the fuselage 101 and higher than the wing 102.

The propellers 112 of the front and rear nacelles 111 are coaxial with their common axis of rotation 113.

The tail section of the vehicle is equipped with a substantially horizontal and slightly dihedral swept back stabilizer 114 and two vertical fins 116 with rudders 117 (the fin 116 and rudder 117 of only one side are visible in this side elevation view).

The diagram also shows the basic lowermost plane 201 of the vehicle.

Due to the water landing mode, the EVTOL WIG vehicle on the diagram is shown with exposed emergency landing system consisting of three retractable hydroskis (only two are visible in this side elevation view) elongated in the longitudinal direction and protruding in the extended position below the level of the bottom of the fuselage 101, wing 102 and the lowermost basic horizontal plane 201 so that the rear end of each hydroski offsets further down from said lowermost basic horizontal plane 201 than the front one.

This water landing system comprises the forward central hydroski 302 and a couple of aft hydroskis 501 (only the port side one is visible in this side elevation view) positioned under planes of the wing 102 symmetrically both sides of the fuselage 101.

The hydroskis of the system arranged the way so that hydrodynamic lift generating surfaces of the forward hydroski 302 arranged in front of the center of gravity and aft hydroskis 501 displaced in the longitudinal direction and located behind the center of gravity lengthwise, which three-point planing hydrodynamic system ensures stable skimming of the vehicle when landing on water at high speed.

To moderate shock loads and soften the impact when touching the surface of the water at high landing speeds, both forward hydroski 302 and aft hydroskis 501 are equipped with shock absorbers 1001.

FIG. 11 depicts a schematic diagram illustrating the front elevation view of a vehicle according to some embodiments and basically corresponding to the embodiment of the FIG. 1, wherein the EVTOL WIG vehicle shown in the mode corresponding emergency landing on water, which vehicle features two lowermost positioned half-planes of the wing 102 extend both sides of the fuselage 101 symmetrically relatively the vertical longitudinal plane of symmetry 301 and comprise horizontal inner sections 103 being adjacent to the basic lowermost plane 201 of the vehicle, outwardly elevating sections 104 and bent down tip sections 105.

The uppermost part of the fuselage 101 is provided with pylons 108 capable of turning about an axis 109 (only the forward pair of pylons 108 is visible in this front elevation view).

Nacelles 111 with propellers 112 (conditionally shown by the contours of the disks of their rotation) are mounted at the tips of the pylons 108 and thus capable to rotate with the rotation of the pylons 108 around the axis 109, while these propulsion units arrange higher than the basic lowermost plane 201 and the wing 102.

The substantially horizontal and slightly dihedral tail stabilizer 114 is also located in the upper part of the fuselage 101.

Two vertical fins 116 (slightly inclined due to the dihedral of the tail stabilizer 114) are mounted one on each of the half-planes of the tail stabilizer 114.

Due to the water landing mode, the EVTOL WIG vehicle on the diagram is shown with exposed emergency landing system consisting of three retractable hydroskis protruding in the extended position below the level of the bottom of the fuselage 101, wing 102 and the lowermost basic horizontal plane 201.

This water landing system comprises the forward central hydroski 302 extending down from the forward part of the fuselage 101 and two aft hydroskis 501 positioned under planes of sections 103 of the wing 102 symmetrically relatively the plane of symmetry 301 and both sides of the fuselage 101, which three-point planing hydrodynamic system ensures stable skimming of the vehicle when landing on water at high speed.

FIG. 12 depicts a schematic diagram illustrating one of possible embodiments of the EVTOL WIG aerial vehicle employing the concept of the Wing-in-Ground Effect (WIGs), being capable to take-off and land vertically (VTOL) and propelled by electric motors (E), while, unlike the embodiment of FIG. 1, e.g., featuring a straight (not swept) wing without bent tips, nacelles each provided with only one propeller and one electric motor, only one central vertical fin with rudder at the tail and aerodynamic control vanes.

The vehicle is shown in the flight mode and comprises a fuselage 101 elongated in the direction of flight and a wing 102 located at the lowermost bottom part of the fuselage 101, while two symmetrical half-planes of said wing extend outwardly on both sides of the fuselage 101.

So that in the principal mode of operation said wing 102 generates an aerodynamic lift with a resultant force located at about the center of gravity in horizontal projection, which aerodynamic lift supports the vehicle in its flight mode, whereas the lowermost location of the wing makes it possible to fully realize the potential efficiency of the WIG concept in excess of the efficiency of conventional aircraft.

The wing 102 consists of substantially horizontal straight (not swept) inner (nearer to the fuselage 101) sections 103 and similarly straight positively inclined outer section 104 with the height increasing towards the tip of the wing.

The substantially horizontal position of the inner sections 103 makes better use of the ground effect, while the positively sloping outer sections 104 allow the vehicle to make banked turns at low altitudes corresponding the ground effect.

Unlike the embodiment of the FIG. 1, the tip section of the wing 102 in this embodiment is not bent down, which design simplifies the structure of wing 102, but introduces some increase in inductive drag and, accordingly, some decrease in the efficiency of the vehicle.

Similarly, unlike the swept forward wing of the embodiment of the FIG. 1, the simpler structurally straight wing 102 of the shown embodiment does not have the self-stabilizing in pitch effect, which also results in some drop in efficiency.

To regulate the lift of this main wing and ensure a proper roll control of the vehicle as an aerial one the wing 102 provided with ailerons 106 and flaps 107.

In order to ensure the vertical takeoff and landing, said vehicle is provided with a propulsion system with a turnable thrust vector, which system comprises four rotatable pylons 108 protruding transversely and substantially horizontally in pairs on both sides of the upper part of the fuselage 101 and forming front and rear coaxial pairs of pylons with axes of rotation 109 and 110 substantially normal to the vertical longitudinal plane of symmetry of the vehicle, so that the axis of rotation of the front pair 109 is located in front, and the rear 110—behind said center of gravity of the vehicle lengthwise, and four nacelles 111 each containing presumably one electric motor and provided with one propeller 112 (conditionally shown by the contours of the disks of their rotation) at the forward end of each nacelle 111, which nacelles 111 mounted on the outer tips of said four rotatable pylons 108 with axes of rotation of said propellers 113 being normal to the axes of rotation of said pylons 109 and 110.

It is assumed that the electric motor in each nacelle is mounted with a drive shaft pointing forward and rotates the front propeller 112.

The top location of the pylons 108, nacelles 111 and propellers 112 removes them from the zone of the most probable damage from accidental debris and spraying and, thereby, increases the durability of the propulsion system, and, moreover, does not prevent the wing 102 from descending into the most economical ground effect flight mode.

All of them: pylons 108, nacelles 111, propellers 112 with their axles 113 are shown in the flight mode assuming horizontal thrust and, accordingly, the horizontal position of the pylons 108, the nacelles 111 and axles 113, while axes 113 of the propellers 112 of the front and rear pylons 108 of one side of the vehicle made coaxial, presupposing that propellers of transversely opposed pylons 108 are counter-rotating.

In this embodiment the vehicle is provided with substantially horizontal swept back tail stabilizer 114 made with a slight dihedral and equipped with conventional for aerial vehicles elevators 115 intended to govern pitch of the vehicle.

The sweep back of the tail stabilizer 114 makes it possible to enhance its “volume” and efficiency without increasing its area and fuselage length.

Because of the straight configuration the inner horizontal sections 103 of the wing 102 not providing self-stabilization pitch effect, the tail stabilizer 114, ceteris paribus, supposed to be made of larger dimensions and area in comparison with the tail stabilizer of the embodiment of the FIG. 1. That to some degree increases the parasitic drag and deteriorates the efficiency of the vehicle.

For directional control the vehicle is equipped with one vertical fin 116 with rudder 117 mounted centrally at the tail and atop of the vehicle's fuselage.

This configuration of the fin 116 and rudder 117, although it simplifies the structural design, but, at the same area, somewhat loses in terms of “volume” and, accordingly, in terms of efficiency to the embodiment of the FIG. 1.

Another factor that reduces effectiveness of such directional controls compared to the embodiment of FIG. 1 is that the center-positioned fin 116 with rudder 117 is not in the wake of the propellers 112.

In order to somewhat improve effectiveness, the vertical fin 116 with rudder 117 made swept back, which configuration increases the “volume” without enlarging their area and elongating the fuselage 101.

The shown embodiment provided with additional control aerodynamic surfaces in the form of turnable vanes 1201 installed in the wakes of the propellers 102 and normal to the axes of rotation 109 and 110 of the corresponding pylons 108.

Turning the vanes 1201 around axes 1202 creates a lateral force that can be used both to move the vehicle sideways (when all the vanes turned in the same direction) and to turn on the spot (in the hovering mode) when turning the vanes 1201 on the forward and aft nacelles 111 in opposite directions, the ability of which, combined with the ability to deflect the nacelles 111 in a vertical position and regulate the thrust of propellers 102, allows full three-dimensional control of the position of the vehicle.

Notwithstanding a bit lower efficiency in comparison with the embodiment of FIG. 1, the shown structurally simplified embodiment, like the embodiment of FIG. 1, still allows realizing the potential efficiency of the WIG concept and, ceteris paribus, ensures aerodynamic efficiency exceeding efficiency of conventional aircraft.

FIG. 13 depicts a schematic diagram illustrating the side elevation view of a vehicle according to some embodiments and basically corresponding to the embodiment of the FIG. 12, wherein the EVTOL WIG vehicle is shown in the flight mode and comprises: a fuselage 101 and the straight (not swept) wing 102 located at the lowermost bottom part of the fuselage and shown by its positively inclined straight (not swept) section 104 with its aileron 106.

Two consecutive-front and rear-nacelles 111 of the one shown side of the vehicle, each of which presumably containing one electric motor driving the front-mounted propeller 112, are located in the upper part of the vehicle at the level of the roof of the fuselage 101 and higher than the wing 102.

The propellers 112 of the front and rear nacelles 111 are coaxial with their common axis of rotation 113.

The tail section of the vehicle is equipped with a substantially horizontal and slightly dihedral swept back stabilizer 114 and one central vertical swept back fin 116 with rudder 117.

The diagram also shows the basic lowermost plane 201 of the vehicle.

The location of the wing 102 directly on and adjacent to the plane 201 allows it to be as close as possible to the surface of the ground or water and, thereby, to maximize the ground effect and the efficiency of the vehicle.

At the same time, the nacelles 111 with propellers 112 are arranged as far as possible from the basic lowermost plane 201 and, accordingly, from sources of debris and spraying.

With this top arrangement, the propellers 112 do not protrude downward from plane 201 and thereby allow the wing 102 to operate at an optimally close distance from the ground or water surface, fully implementing the ground effect and maximizing the efficiency of the vehicle.

Control vanes 1201 installed in the wakes behind the propellers 102, capable of rotating relative to the axes 1202, make it possible to enhance the maneuverability of the vehicle of this embodiment.

FIG. 14 depicts a schematic diagram illustrating the front elevation view of a vehicle according to some embodiments and basically corresponding to the embodiment of the FIG. 12, where two lowermost positioned half-planes of the wing 102 extend both sides of the fuselage 101 symmetrically relatively the vertical longitudinal plane of symmetry 301 and comprise horizontal inner sections 103 being adjacent to the basic lowermost plane 201 of the vehicle and outwardly elevating sections 104.

The uppermost part of the fuselage 101 is provided with pylons 108 capable of turning about an axis 109 (corresponding to the forward pair of pylons 108 visible in this front elevation view).

Nacelles 111, each of which presumably containing one electric motor driving the front-mounted propeller 112, are mounted on the outer tips of the pylons 108 and thus can rotate with the rotation of the pylons 108 around the axis 109.

Thus, the wing 102 is located in the most favorable position for the implementation of the ground effect, and the pylons 108 with nacelles 111 and propellers 112 are removed to the greatest distance from the base plane 201 and the wing 102, which increases the survivability of the propulsion system and does not prevent the wing 102 from effectively implementing the ground effect.

Control vanes 1201 installed in the wakes behind the propellers 102, capable of rotating relative to the axes 1202, make it possible to enhance the maneuverability of the vehicle of this embodiment.

The substantially horizontal and slightly dihedral tail stabilizer 114 is also located in the upper part of the fuselage 101.

The single vertical fin 116 is positioned in the vertical longitudinal plane of symmetry 301 and mounted at the tail of the vehicle atop the fuselage 101.

The forward bottom part of the fuselage 101 is equipped with a retractable hydroski 302 depicted for the shown flight mode in the retracted position.

FIG. 15 depicts a schematic diagram illustrating the plan view of a vehicle according to some embodiments and basically corresponding to the embodiment of the FIG. 12, where the symmetrical relatively the vertical longitudinal plane of symmetry 301 EVTOL

WIG vehicle is shown in the flight mode and comprises a fuselage 101 and a straight (not swept) wing 102, which half-planes extend both sides of the fuselage 101 and include inner sections 103 with their flaps 107 and outer sections 104 with their ailerons 106.

Two pairs of turnable front and rear pylons 108 with their axes of rotation 109 and 110 protrude transversally and normally to the plane 301 both sides of the fuselage 101, while the forward axis of rotation 109 supposed to be arranged in front of the center of gravity of the vehicle and the aft axis of rotation 110—behind the center of gravity of the vehicle lengthwise.

Nacelles 111, each of which presumably containing one electric motor driving the front-mounted propeller 112, are mounted on the outer tips of the pylons 108 and thus can rotate with the rotation of the pylons 108 around the axes 109 and 110, while the two forward propulsion units arrange in front of the wing 102 and the two aft propulsion units—behind the wing 102 lengthwise not overlapping the wing 102.

The propellers 112 of the front and rear nacelles 111 of each side of the vehicle are coaxial with their common axis of rotation 113.

Control vanes 1201 installed in the wakes behind the propellers 102 make it possible to enhance the maneuverability of the vehicle of this embodiment.

The tail section of the vehicle features a swept back stabilizer 114 with its elevators 115 and the single vertical fin 116 positioned in the vertical longitudinal plane of symmetry 301.

What I claim is:

1. An aerial and preferably marine vehicle intended to operate in its principal mode in the vicinity of surface of water or land employing the concept of the Wing-in-Ground Effect and being capable to take-off and land vertically, which vehicle comprises:
its center of gravity, the vertical longitudinal plane of symmetry and the lowermost basic horizontal plane,
a fuselage elongated in the direction of flight and substantially symmetrical relatively said vertical longitudinal plane,
a propulsion-free wing located at the lowermost bottom part of the fuselage and adjacent to said lowermost basic horizontal plane, so that two provided with flaps and ailerons half-planes of said wing extend outwardly on both sides of the fuselage and symmetrically relatively said plane of symmetry, while in the principal mode of operation said wing generates an aerodynamic lift with a resultant force located at about said center of gravity in horizontal projection, which aerodynamic lift supports the vehicle in its flight mode,
a substantially horizontal tail stabilizer with its symmetrical relatively said plane of symmetry half-planes provided with elevators, located at the lengthwise utmost aft and upper part of said fuselage, and at least one substantially vertical fin with rudder located at the lengthwise utmost aft part of said vehicle,
at least three retractable hydroskis built in the bottom part of the vehicle and intended for emergency landing on water, which hydroskis being elongated in the longitudinal direction protrude in the extended position below said lowermost basic horizontal plane, so that the rear end of each hydroski offsets further down from said lowermost basic horizontal plane than the front one,
while in order to ensure the vertical takeoff and landing, said vehicle is provided with a propulsion system consisting of four propulsion units with a turnable thrust vector, which system comprises:
four non-lift-generating rotatable pylons protruding transversely and substantially horizontally in pairs on both sides of the upper part of the fuselage and forming front and rear coaxial pairs of pylons with axes of rotation substantially normal to said vertical longitudinal plane of symmetry, so that the axis of rotation of the front pair is located in front, and the rear—behind said center of gravity of the vehicle lengthwise,
four nacelles containing electric motors and provided with propellers, which nacelles mounted on the outer tips of said four rotatable pylons with axes of rotation of said propellers being normal to the axes of rotation of said pylons, so that the rotation of the pylons leads to the rotation of the axes of the propellers in the planes being substantially parallel to said vertical longitudinal plane of symmetry, from a substantially horizontal position of the axes of the propellers corresponding the flight mode to a substantially vertical position corresponding vertical takeoff, hover, and landing modes of said vehicle,
whereas the two forward propulsion units are positioned in front of said wing and two aft propulsion units are positioned behind said wing lengthwise, so that the wing and the four propulsion units are separated and spaced vertically and horizontally, meaning that the projections of the four propulsion units on the transverse plane arrange higher than the projection of the wing, and the projections of the four propulsion units and the wing on the horizontal plane do not overlap.

2. A vehicle according to 1., wherein each of the two half-planes of said wing consists of a substantially horizontal inner section and a positively inclined outer section with the height from said lowermost basic horizontal plane increasing towards the tip of the wing.

3. A vehicle according to 2., wherein tip portions of said positively inclined outer sections of the wing are made bent down.

4. A vehicle according to 2., wherein said two substantially horizontal inner sections of half-planes of said wing are made swept forward, so that outer and distant from the fuselage sections of said inner sections of half-planes are arranged upstream of the adjacent to the fuselage root sections.

5. A vehicle according to 1., wherein said planes of rotation of the axes of propellers caused by rotation of the front and rear pylons on each of the sides are made coplanar.

6. A vehicle according to 5., wherein the horizontal in the flight mode axes of the propellers of the front and rear pylons on each of the sides are made coaxial.

7. A vehicle according to 6., wherein propellers of transversely opposed pylons are made counter-rotating.

8. A vehicle according to 6., wherein each elongated relatively the axis of propeller nacelle is provided with one propeller at one of its lengthwise ends and propellers of the front and rear pylons on each of the sides are made counter-rotating.

9. A vehicle according to 6., wherein each elongated relatively the axis of propeller nacelle is provided with two counter-rotating propeller at one of its lengthwise ends.

10. A vehicle according to 6., wherein each elongated relatively the axis of propeller nacelle is provided with one propeller at each of its lengthwise ends and these propellers of each nacelle are made counter-rotating.

11. A vehicle according to 1., wherein each nacelle contains one electric motor with its driving shaft facing forward and driving one propeller at the front end of said nacelle, or with its driving shaft facing aft and driving one propeller at the rear end of said nacelle.

12. A vehicle according to 1., wherein each nacelle contains one electric motor with its driving shaft facing forward and driving one propeller at the front end of said nacelle, and one electric motor with its driving shaft facing aft and driving one propeller at the rear end of said nacelle.

13. A vehicle according to 1., wherein each nacelle contains one electric motor driving counter-rotating propellers at one of the ends of said nacelle.

14. A vehicle according to 1., wherein said propulsion electric motors are powered by a hybrid power-supplying system containing at least one electric power generation set, consisting of an internal combustion engine or turbine driving a generator, and an electric buffer battery recharged by said electric power generation set and supplying electric power to said propulsion electric motors.

15. A vehicle according to 1., wherein the lengthwise utmost aft part of said vehicle is provided with two vertical fins with rudders each mounted on one of half-planes of said substantially horizontal tail stabilizer and each of said two vertical fins with rudders is arranged in the wake of propellers of corresponding side of the vehicle.

16. A vehicle according to 1., wherein at least two of said hydroskis are arranged symmetrically both sides of said vertical longitudinal plane with their hydrodynamic lift generating surfaces in the horizontal projection displaced in the longitudinal direction from the center of gravity and hydrodynamic lift generating surface of at least one symmetrical relatively said vertical longitudinal plane hydroski is displaced in the horizontal projection lengthwise relative the center of gravity in the opposite direction.

17. A vehicle according to 1., wherein said hydroskis are provided with shock absorbers.

18. A vehicle according to 1., wherein each of said nacelles is provided with at least one aerodynamic control vane positioned in the wake of nacelle's propeller, which vane is arranged substantially normally to the axis of the propeller and the axis of rotation of corresponding pylon, and turnable around the axis being substantially normal to said axis of the propeller and the axis of rotation of corresponding pylon.

19. A vehicle according to 18., wherein said aerodynamic control vane represents the aft rudder part of a fin positioned in the wake of nacelle's propeller, which fin is arranged substantially normally to the axis of the propeller and the axis of rotation of corresponding pylon.

20. A vehicle according to 1., provided with a landing gear comprising at least three sprung retractable wheels.
